(19) United States
(12) Patent Application Publication
(10) Pub. No.: US 2024/0017781 A1
(43) Pub. Date: Jan. 18, 2024

(54) CARGO PACK, FOR EXAMPLE FOR MOUNTING ON A BICYCLE

(71) Applicant: TAILFIN LIMITED, Bristol (GB)

(72) Inventors: Nicholas BROADBENT, Long Ashton North Somerset (GB); Robert PHILLIPS, Bristol (GB)

(73) Assignee: TAILFIN LIMITED, Bristol (GB)

(21) Appl. No.: 18/353,239

(22) Filed: Jul. 17, 2023

(30) Foreign Application Priority Data
Jul. 18, 2022 (GB) 2210531.6

(51) Int. Cl. B62J 9/21

(52) U.S. Cl. CPC B62J 9/21

(57) ABSTRACT

There is described a cargo pack 14 comprising: a flexible container having a tubular outer wall 16, an opening at one end of the outer wall 16, a closure arrangement for closing the opening, the closure arrangement including a buckle 26 attached to the end of the outer wall 16, and a row of hooks 24 provided on the outer wall and extending in the direction away from the opening. The hooks 24 are selectively engageable by the buckle 26 to retain the closure arrangement in a closed condition. There is also described a bicycle provided with a cargo pack 14.

This invention relates to a cargo pack, and is particularly, although not exclusively, concerned with a cargo pack to be mounted on a bicycle, for example on the bicycle handlebars.

Bikepacking is a popular leisure pursuit which often involves multi-day touring on a bicycle, often an off-road bicycle such as a mountain bike. Everything needed for touring is carried on the bicycle or by the rider. There is therefore a need for luggage containers, often referred to as cargo packs, which can be attached to the bicycle and can be loaded with equipment such as clothing, sleeping bags and food.

“Soft” packs, such as collapsible bags, are known for this purpose, but pose particular problems. When such packs are mounted on the bicycle handlebars, it is important for them to be kept away from control elements such as brake levers, gear change controls, etc. Also, it is desirable for the packs to be centralised on the handlebars to avoid imbalance. These requirements can be difficult to achieve if the contents of the pack may vary in volume, for example if an item of clothing is taken out of, or placed in, the pack.

A bag of this kind is disclosed in US2011069909A1. The internal volume of the bag is compressed to suit the contents by means of straps which are interconnected by buckles and are then tensioned by pulling tight through the buckle components. This solution has several problems when used for bags that are to be attached to a bicycle and manipulated by a possibly gloved hand, especially if the operation is to be carried out one-handed while the other hand is, for example, steadying the bicycle.

One problem is that the flexible straps allow the buckle components to hang loose so that two hands are needed to capture both buckle components and bring them together. Tensioning the straps after connecting the buckle components also usually requires two hands, one to pull the strap and the other to hold the bag steady. Additionally, after tensioning the straps, there can be free strap ends which flap in the airstream and can become caught in parts of the bicycle or otherwise provide a source of irritation to the rider.

DE202007010103U1 and USD909063S disclose carriers which allow different closure positions by way of tapes which are secured to the carrier and provide a series of loops that can be engaged by a suitable closure element. Such looped tapes are not suitable for supporting significant tension and it is also often difficult to engage the closure element with the selected loop using just one hand.

CN2555680Y discloses a schoolbag having a complex internal structure to enable its depth to be expanded and contracted to suit the number and size of books to be carried. The schoolbag has a lid with straps carrying catches which are engageable with any one of a series of slots provided on the bag. The catches and slots simply serve to hold the lid closed but do not serve to compress the bag contents.

There is a need for a bag which can be compressed to minimise its volume, and possibly that of its contents such as clothing, in order to minimise its interference with a bicycle rider or the mechanism of the bicycle, and which can easily be opened and closed, even with one hand.

According to the present invention there is provided a cargo pack comprising:
a flexible container having a tubular outer wall,
an opening at one end of the outer wall,
a closure arrangement for closing the opening, the closure arrangement including a buckle attached to the end of the outer wall,
a row of hooks provided on the outer wall and extending in the direction away from the opening, wherein the hooks are selectively engageable by the buckle to retain the closure arrangement in a closed condition.

Each hook may define a recess for receiving a retaining element of the buckle. The recess may be directed away from the opening. The interior of the recess may communicate with the exterior through a mouth which is narrower than the interior of the recess. Thus, the retaining element of the buckle may be a press fit through the mouth of the recess.

The row of hooks may be mounted on a common base, in which case the hooks and the base may be formed as a unitary component, which may be formed from a plastics material by moulding.

The common base may be secured to the material of the outer wall. The base may be mounted on the outer wall for displacement towards and away from the opening. In one embodiment, the base is mounted displaceably on a rail which is secured to the outer wall. Locking means may be provided for locking the base to the rail in a selected position.

The hooks may be mounted on a pedestal which projects from the base. At least one slot may extend through the pedestal between the base and the hooks. The slot may be employed to receive a compression strap, or other form of strap, for example to apply compression to the pack.

The row of hooks may comprise any number of hooks, but in preferred embodiments there are not fewer than three hooks and not more than ten hooks.

The tubular outer wall may have a second opening, the openings being situated at opposite ends of the tubular outer wall, the second opening being provided with a respective closure arrangement and a respective row of hooks.

The present invention also provides a bicycle provided with a cargo pack as defined above. The cargo pack may be mounted on handlebars of the bicycle.

For a better understanding of the present invention, and to show more clearly how it may be carried into effect, reference will now be made, by way of example, to the accompanying drawings, in which:

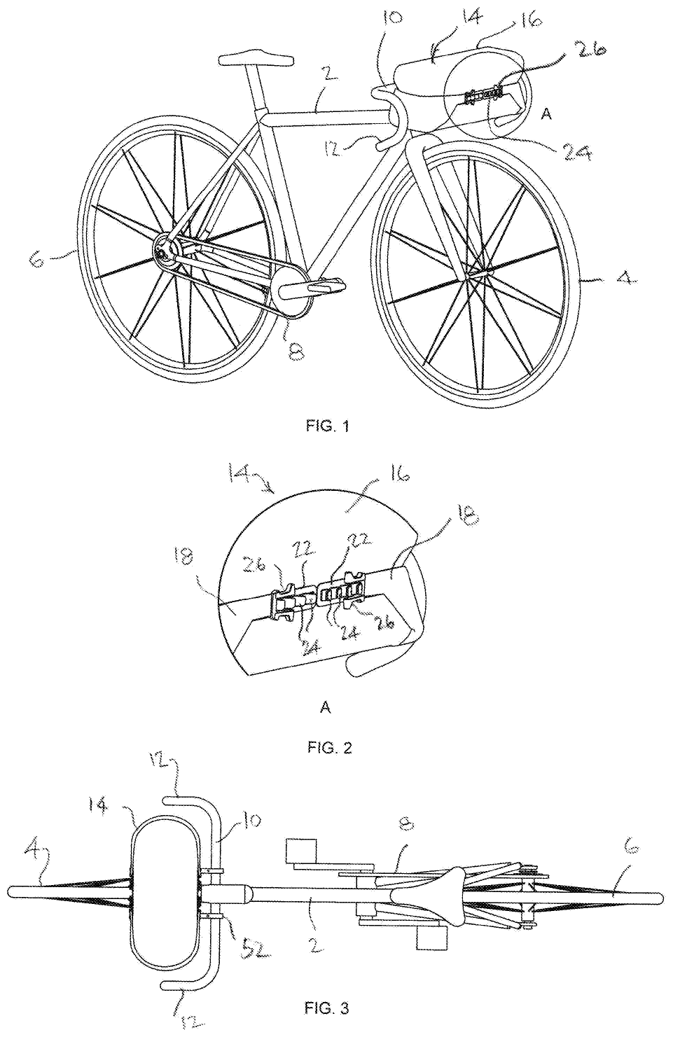

FIG. 1 shows a bicycle provided with a handlebar-mounted cargo pack;

FIG. 2 is a detailed view of a closure mechanism shown in the region A in FIG. 1;

FIG. 3 is a plan view of the bicycle of FIG. 1;

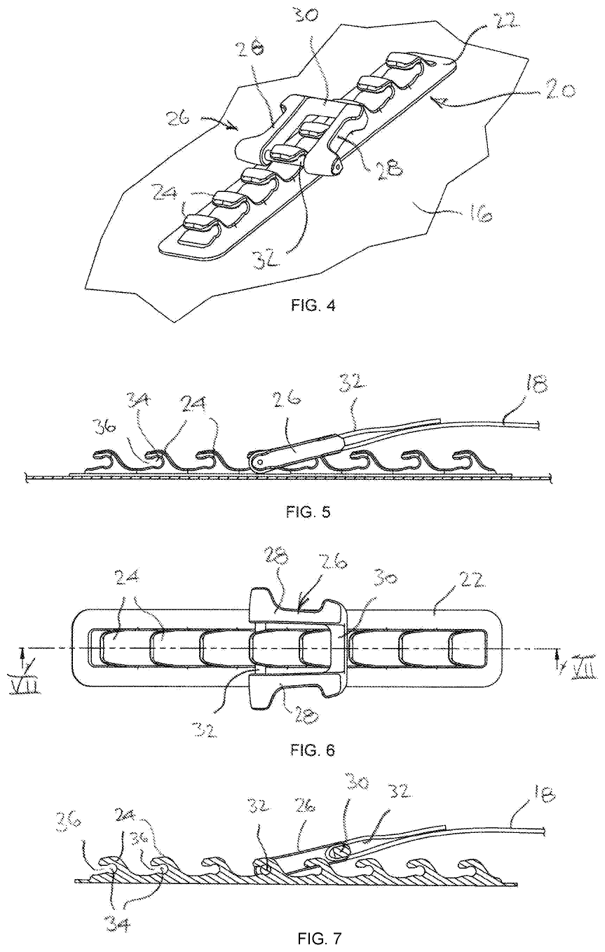

FIG. 4 is an enlarged view of the closure mechanism of FIG. 2, comprising a buckle and a row of hooks;

FIG. 5 is a side view of the closure mechanism of FIG. 4;

FIG. 6 is a plan view of the closure mechanism;

FIG. 7 is a sectional view taken on the line VII-VII in FIG. 6;

Figure is a schematic diagram showing a modification of the closure mechanism of FIG. 7;

FIG. 9 is a perspective view of a modified row of hooks;

FIG. 10 is a side view of the row of hooks of FIG. 9;

FIG. 11 is a sectional view taken on the line XI-XI;

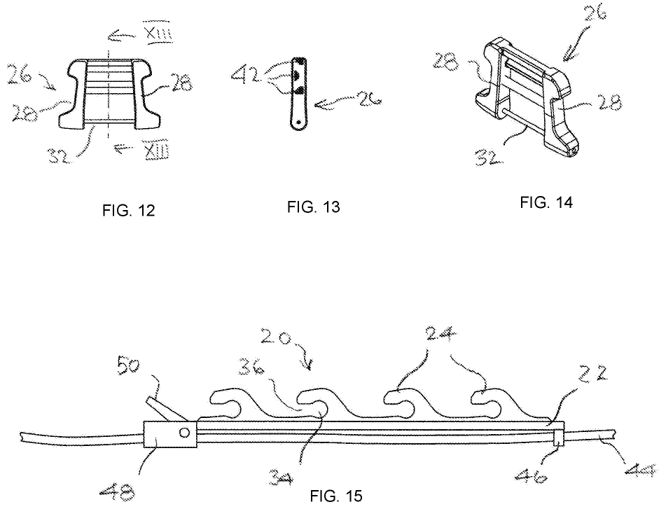

FIG. 12 is a plan view of a modified form of buckle;

FIG. 13 is a sectional view of the buckle of FIG. 12 taken on the line XIII-XIII;

FIG. 14 is a perspective view of the buckle of FIGS. 12 and 13; and

FIG. 15 is a side view of an alternative row of hooks.

FIG. 1 shows a bicycle in schematic form. The bicycle has a frame 2, front and rear wheels 4, 6, and a chain drive mechanism 8. The bicycle has handlebars 10, which, in the embodiment illustrated, are drop handlebars terminating at drops 12, although other handlebar styles are possible.

A cargo pack 14 is secured to the handlebars 10 and is situated between the drops 12. The cargo pack 14 is a ‘soft’ pack, made from a flexible, waterproof material. The pack comprises a body 16 of generally tubular form which is open at its ends. The openings thus formed can each be closed by a closure arrangement (not shown in detail) but which, in general, involves folding over the material of the pack to achieve a watertight seal.

As shown in FIG. 2, after closing, the ends 18 of the pack material are brought towards each other and secured to the bag material as is described below.

Referring to FIG. 4, a unitary component 20 is secured to the material of the body 16 of the pack 14. This unitary component 20 comprises a base 22 on which is provided a row of hooks 24. In the embodiment shown in FIG. 4, there are eight such hooks 24, while in the embodiment shown in FIG. 2, there are four of the hooks 24. It will be appreciated that any number of hooks 24 may be provided to suit any particular application, although in general it is envisaged that not fewer than three and not more than ten hooks 24 would be required.

The component 20 may be made, for example by moulding, from any suitable material, for example resilient material which may be a plastics material such as high-density polyethylene (HDPE). If HDPE or another thermoplastic material such as thermoplastic polyurethane (TPU) is used, the component may be secured to the material of the bag 14 by welding, such as radio-frequency (RF) welding. Alternatively, adhesive bonding or stitching may be employed.

FIG. 4 also shows a buckle 26 which is secured to the respective end 18 of the pack material. The buckle comprises opposite side members 28 which are interconnected at one end by an attachment bar 30 and at the other end by a circular retaining bar 32. As shown in FIGS. 5 and 7, the attachment bar 28 is retained within a loop 34 of the pack end 18, or of a strap secured to the pack end 18.

The buckle 26, apart from the retaining bar 32, may be formed by moulding from a suitable plastics material, such as HDPE. The retaining bar 32 may comprise a cylindrical metallic component.

As shown in FIG. 5, each hook 24 comprises a recess 34 for receiving the retaining bar 32 of the buckle 26. The recess 34 opens at a mouth 36 which is narrower than the interior of the recess 34. As shown in FIG. 7, the retaining bar 32 of the buckle 26 is sized to fit closely within the interior of the recess 34. This means that the retaining bar 32 is a light press fit through the mouth 36, which is accommodated by resilient deflection of the hook 24. Consequently, once the retaining bar 32 is seated within the recess 34, it is retained against accidental displacement out of the recess past the mouth 36.

As shown in FIGS. 5 to 7, the buckle 26, when engaged with one of the hooks 24, lies obliquely with respect to the row of hooks 24. Also, the buckle 26 has cut outs on each side. These features make the buckle easier to grasp when releasing it from the hooks 24.

As shown in FIG. 4, the retaining bar 32 is cylindrical with a circular cross-section, and is received in a corresponding part-cylindrical recess 34 of the respective hook 24. The mouth 36 of the recess 34 is defined between almost parallel surfaces, which are slightly tapered in the direction into the recess 34.

In an alternative embodiment, the retaining bar 32 may be non-cylindrical and may have a profile which enables it to enter a suitably shaped recess in one orientation of the buckle 26, but not in another. Thus, to engage the buckle 26 with the hook 24, the buckle must be presented in one orientation, and then rotated to a tensioned orientation, under the pull of the end or strap 18, in which it is locked within the recess 34. To disengage the buckle, it must be returned to the original orientation so that the bar 32 can be moved out of the recess 34.

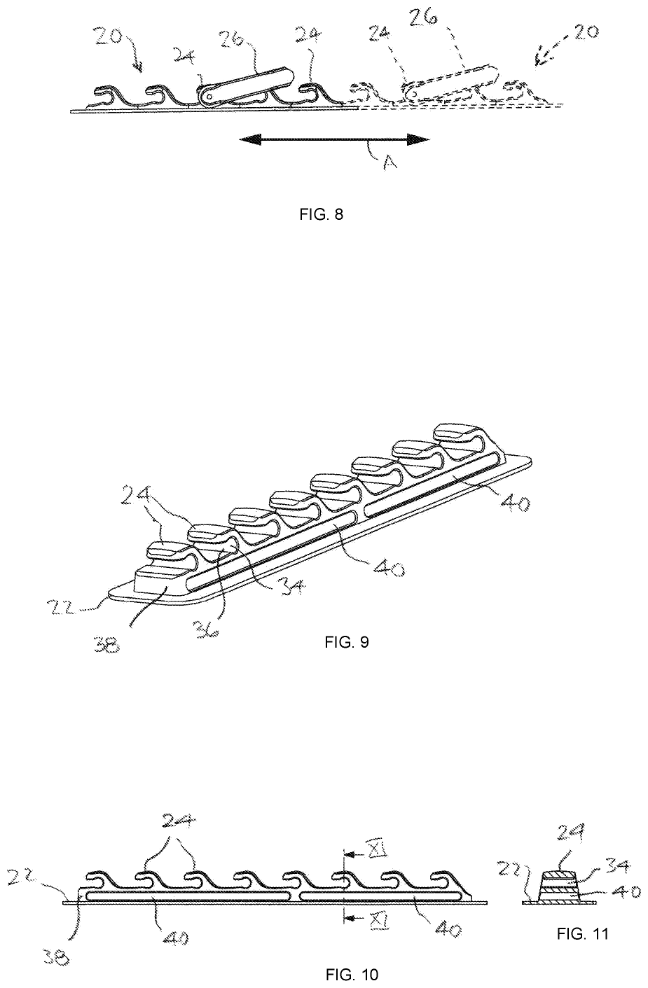

FIG. 8 shows, in diagrammatic form, the possibility of the component 20 being mounted displaceably on the material of the pack 14 so that it can move in its lengthwise direction as indicated by the arrow A. Thus, if the pack 14 is not completely filled, the component 20 can be positioned as shown in solid outline so that the buckle 26 can be fitted in one of the hooks 24 situated towards the left as shown in FIG. 8, i.e. away from the opening of pack which is positioned to the right of FIG. 8. If the bag is filled more fully, the solid outline position of the component 20 could mean that the buckle 26 cannot reach as far as the hook 20 situated to the right-hand end of the component 20. In this situation, the component 20 can be displaced to the right along the pack, to the position shown in dotted outline, and fixed in this position so that the buckle 26 can engage one of the hooks 24 in the new position of the component 20.

FIGS. 9 to 11 show a modified form of the component 20 in which the hooks 24 are elevated above the base 22 on a pedestal 38. The pedestal 38 is provided with one or more slots 40 (two are shown in FIG. 9). The slots 40 can accommodate straps, for example compression straps for compressing the pack and its contents in order to reduce their overall volume. This avoids the need for compression straps to pass over the hooks 24, which would obstruct the buckle 26.

FIGS. 12 to 14 show a modified buckle 26. In this embodiment, the attachment bar is replaced by three “ladder lock” bars 42 to enable a strap to be attached releasably and adjustably to the buckle 26 in a conventional manner.

FIG. 15 shows a practical embodiment for mounting the component 20 displaceably on the pack 14, as shown in FIG. 8. In the embodiment of FIG. 15, a track or rail 44 is fixed, for example at its ends, to the material of the pack 14. The component 20 is provided at one end with a projection 46 from the base 22, which has a slot through which the rail 44 extends. At the opposite end of the base 22, there is a clamping device 48 comprising a body, also provided with a slot for the rail 44, which carries a pivotable lever 50 provided with a cam (not shown) which can be pivoted into and out of engagement with the rail 44. Thus, when in a release position, in which the cam is disengaged from the rail 44, the component 20 can be displaced along the rail 44 to a desired position. When in the desired position, the lever 50 can be moved to a locking position in which the cam is pivoted into firm engagement with the rail 44, to lock the component 20 in position.

For use, the pack 14 is supported on the handlebars 10 of the bike by a suitable support mechanism 52. The pack 14 is supported out of contact with the front wheel 4 or any other moving part of the bicycle. It sits between the drops 12 of the handlebars 10. The pack 14 can be loaded with cargo, such as clothing, camping equipment, etc either before or after the pack 14 is fitted to the handlebars 10. Loading can take place through either or both of the ends of the tubular body 16. The buckles 26 and the hooks 24 provide a closure arrangement which both closes the ends of the body 16 of the pack 14 and pulls the ends inwards of the pack 14 in order to compress the pack 14 in the direction parallel to the handlebars 10. Thus, each end 18 of the body material is pulled by hand towards the centre of the pack 14 and engaged with an appropriate one of the hooks 24 which will hold the pack ends under tension. As mentioned above, the profile of the hooks 24, having a mouth 36 which is narrower than the interior recess 34, means that the retaining bar 32 of the buckle 26 is fitted into the respective hook 24 with a click action which provides tactile confirmation that the buckle is properly engaged with the hook 24, as well as resisting unintentional disengagement of the buckle 26 from hook 24.

The closure arrangement provided by the present invention enables the pack 14 to be compressed in a simple manner without requiring manipulation of adjustable straps. This avoids the need to manage the free ends of any such straps, and also enables compression of the bag by hand (possibly a gloved hand) in a simple and reliable manner.

With the embodiment shown in FIGS. 9 to 11, further compression straps (not shown) can be placed round the pack 14 and passed through the slots 40 in the pedestal 38. This enables the size of the pack 14 to be minimised, further avoiding inconvenience to the rider of the bicycle.

If the embodiment of FIGS. 7 and 13 is employed, the component 20 can be adjusted along the length (i.e. parallel to the handlebars 10) of the pack 14 to ensure that the buckle 26 is able to engage a hook that provides the required tension, whatever the volume of material placed in the pack 14.

For the avoidance of doubt, the present application extends to the subject-matter described in the following numbered paragraphs (referred to as “Para” or “Paras”):

Para 1. A cargo pack comprising a flexible container having a tubular outer wall provided with an opening at one end, the opening being closable by a closure arrangement which includes a buckle attached to the end of the outer wall, the outer wall having a row of hooks extending in the direction away from the opening, the hooks being selectively engageable by the buckle to retain the closure arrangement in a closed condition.

Para 2. A cargo pack as in Para 1, in which each hook defines a recess for receiving a retaining element of the buckle.

Para 3. A cargo pack as in Para 2, in which the recess is directed away from the opening.

Para 4. A cargo pack as in Para 2 or 3, in which the interior of the recess communicates with the exterior through a mouth which is narrower than the interior of the recess.

Para 5. A cargo pack as in Para 4, in which the retaining element of the buckle is a press fit through the mouth of the recess.

Para 6. A cargo pack as in any one of the preceding Paras, in which the row of hooks mounted on a common base.

Para 7. A cargo pack as in Para 6, in which the hooks and the base are formed as a unitary component.

Para 8. A cargo pack as in Para 7, in which the unitary component is formed from a plastics material by moulding.

Para 9. A cargo pack as in any one of Paras 6 to 8, in which the common base are secured to the material of the outer wall.

Para 10. A cargo pack as in any one of Paras 6 to 9, in which the base is mounted on the outer wall for displacement towards and away from the opening.

Para 11. A cargo pack as in Para 10, in which the base is mounted displaceably on a rail which is secured to the outer wall.

Para 12. A cargo pack as in Para 11, in which locking means is provided for locking the base to the rail in a selected position.

Para 13. A cargo pack as in any one of Paras 6 to 12, in which the hooks are mounted on a pedestal which projects from the base.

Para 14. A cargo pack as in Para 13, in which at least one slot extends through the pedestal between the base and the hooks.

Para 15. A cargo pack as in any one of the preceding Paras, in which the row of hooks comprises not fewer than three hooks and not more than ten hooks.

Para 16. A cargo pack as in any one of the preceding Paras, in which the tubular outer wall has a second opening, the openings being situated at opposite ends of the tubular outer wall, the second opening being provided with a respective closure arrangement and a respective row of hooks.

Para 17. A bicycle provided with a cargo pack as in any one of the preceding Paras.

Para 18. A bicycle as in Para 17, in which the cargo pack is mounted on handlebars of the bicycle.

We claim:

1. A cargo pack comprising:
a flexible container having a tubular outer wall:
an opening at one end of the outer wall,
a closure arrangement for closing the opening, the closure arrangement including a buckle attached to the end of the outer wall,
a row of hooks provided on the outer wall and extending in the direction away from the opening, wherein the hooks are selectively engageable by the buckle to retain the closure arrangement in a closed condition.

2. A cargo pack as claimed in claim 1, wherein the buckle is provided with a retaining element and wherein each hook defines a recess configured to receive the retaining element.

3. A cargo pack as claimed in claim 2, wherein the recess is directed away from the opening.

4. A cargo pack as claimed in claim 2, wherein the interior of the recess communicates with the exterior through a mouth which is narrower than the interior of the recess.

5. A cargo pack as claimed in claim 4, wherein the retaining element of the buckle is configured to be a press fit through the mouth of the recess.

6. A cargo pack as claimed in claim 1, wherein the row of hooks is mounted on a common base.

7. A cargo pack as claimed in claim 6, wherein the hooks and the base are formed as a unitary component.

8. A cargo pack as claimed in claim 7, wherein the unitary component is formed from a plastics material by moulding.

9. A cargo pack as claimed in claim 6, wherein the common base is secured to the material of the outer wall.

10. A cargo pack as claimed in claim 6, wherein the base is mounted on the outer wall for displacement towards and away from the opening.

11. A cargo pack as claimed in claim 7, wherein the base is mounted on the outer wall for displacement towards and away from the opening.

12. A cargo pack as claimed in claim 8, wherein the base is mounted on the outer wall for displacement towards and away from the opening.

13. A cargo pack as claimed in claim 9, wherein the base is mounted on the outer wall for displacement towards and away from the opening.

14. A cargo pack as claimed in claim 10, wherein a rail is secured to the outer wall and wherein the base is mounted displaceably on the rail.

15. A cargo pack as claimed in claim 14, wherein locking means is provided for locking the base to the rail in a selected position.

16. A cargo pack as claimed in claim 6, in which the hooks are mounted on a pedestal which projects from the base.

17. A cargo pack as claimed in claim 16, wherein at least one slot extends through the pedestal between the base and the hooks.

18. A cargo pack as claimed in claim 1, wherein the row of hooks comprises not fewer than three hooks and not more than ten hooks.

19. A cargo pack as claimed in claim 1, wherein the tubular outer wall has a second opening, the openings being situated at opposite ends of the tubular outer wall, the second opening being provided with a respective closure arrangement and a respective row of hooks.

20. A bicycle provided with a cargo pack comprising:
a flexible container having a tubular outer wall:
an opening at one end of the outer wall,
a closure arrangement for closing the opening, the closure arrangement including a buckle attached to the end of the outer wall,
a row of hooks provided on the outer wall and extending in the direction away from the opening, wherein the hooks are selectively engageable by the buckle to retain the closure arrangement in a closed condition.

21. A bicycle as claimed in claim 20, wherein the bicycle is provided with handlebars and wherein the cargo pack is mounted on the handlebars.
